(19) United States
(12) Patent Application Publication
(10) Pub. No.: US 2026/0318349 A1
(43) Pub. Date: Oct. 15, 2026

(54) BEARING PRELOAD SPINDLE NUT ASSEMBLY

(71) Applicant: ArvinMeritor Technology, LLC, Troy, MI (US)

(72) Inventors: Prathap N. KRISHNAN, Bangalore (IN); Puneeth H. PARTHA SHETTY, Chikmagalur (IN); Subrahmanya CHOLOCHAGUDDA, Bangalore (IN); Christopher J. WITTRY, Saint Clair Shores, MI (US)

(21) Appl. No.: 19/174,131

(22) Filed: Apr. 9, 2025

(51) Int. Cl. F16C 33/58; F16C 43/04

(52) U.S. Cl. CPC F16B 39/26

(57) ABSTRACT

A spindle nut assembly secures a wheel hub containing wheel bearings on an axially extending wheel spindle for rotation about the spindle. The spindle nut assembly includes an internally threaded nut having an axis that coincides with the spindle axis, and includes a torque element situated axially adjacent the nut. The assembly also includes an assembly cage that retain the nut and torque element together under axially compressive spring forces. The cage has a thrust end and a locking end axially spaced apart. A first pressure ring is interposed between the nut and torque element, and a second pressure ring is interposed between the nut and the thrust end of the cage. Together, the first and second pressure rings cooperate to provide a torque threshold limit for preloading the wheel bearings whenever the torque element is rotated in a first direction while being axially urged against the nut.

### FIELD

The present disclosure relates to spindle nut assemblies for securing wheel hubs on wheel spindles, and particularly to such assemblies capable of providing desirable preloads on roller bearings contained within the wheel hubs.

### BACKGROUND

A wheel hub is configured to rotate on a fixed axle or spindle. At its outboard end, the hub is typically secured to a spindle by a spindle nut, the nut being axially threaded on the spindle. The hub is rotatably supported on the spindle by bearings which permit the hub to rotate freely about the spindle. Significant efforts have been made to avoid undesirable dislodgement of wheel end components from hubs.

Most wheel hubs associated with highway tractor trailers contain pairs of bearings, each typically comprising tapered roller bearings. Each bearing is normally referenced with respect to its positioning on the spindle as either inboard or outboard. Spindle nut assemblies have been used not only for securing wheel hubs to spindles, but also for preloading both inboard and outboard wheel hub bearings to assure their proper placements and functioning within the hubs. Ideally, spindle nut assemblies fundamentally act to securely lock hubs to spindles in ways that avoid risk of any dislodgement of the hubs from spindles.

### SUMMARY

In one aspect of this disclosure, a spindle nut assembly secures a wheel hub to a wheel spindle. The hub is supported on wheel bearings for rotation about an axis of the spindle. The assembly includes an axis configured to coincide with the axis of the spindle. The assembly includes a) an internally threaded nut, b) a torque element situated axially adjacent the nut, and c) a cage holding the nut and torque element axially together under compressive spring forces. The cage includes a thrust end and a locking end axially spaced from the thrust end. The spindle nut assembly further includes a first pressure ring axially interposed between the nut and the torque element, and a second pressure ring axially interposed between the nut and the thrust end. The first and second pressure rings cooperate to provide a torque threshold limit for preloading the wheel bearings when the torque element is rotated in a first direction while axially urged against the nut.

In another aspect of this disclosure, a spindle nut assembly secures a wheel hub to a wheel spindle, the hub supported on wheel bearings for rotation about an axis of the spindle. The assembly includes an axis configured to coincide with the axis of the spindle. The assembly includes a) an internally threaded nut; b) a torque element situated axially adjacent the nut; and c) a cage holding the nut and torque element axially together under compressive spring forces. The cage includes a thrust end and a locking end axially spaced from the thrust end. The assembly further includes a wave spring axially interposed between the nut and the torque element, and a plurality of pressure rings axially interposed between the nut and the thrust end. The wave spring and pressure rings cooperate to provide a torque threshold limit for preloading the wheel bearings when the torque element is rotated in a first direction while axially urged against the nut. The locking end and the torque element form a spindle nut assembly lock for selectively preventing rotation of the torque element and nut relative to the cage.

In yet another aspect of this disclosure, a method of forming a spindle nut assembly for securing a wheel hub to a wheel spindle, with the hub being supported on wheel bearings for rotation about an axis of the spindle, and the assembly including an axis configured to coincide with the axis of the spindle includes the steps of:
a) forming an internally threaded nut;
b) forming a torque element to be situated axially adjacent the nut;
c) forming a cage to hold the nut and torque element axially together under compressive spring forces, with the cage including a thrust end, and with the cage further including a locking end axially spaced from the thrust end;
d) forming a wave spring to be axially interposed between the nut and the torque element;
e) forming a plurality of friction rings to be axially interposed between the nut and the thrust end; and
f) assembling the torque element, the nut, the wave spring, and the friction rings within the cage;
the wave spring and friction rings defining at least two axially spaced components configured to provide a torque threshold limit for preloading the wheel bearings when the torque element is axially urged against the nut and rotated in a first direction.

### BRIEF DESCRIPTION OF THE DRAWINGS

The foregoing and other features and advantages will be discussed in detail in the following non-limiting description of specific embodiments in connection with the accompanying drawings, in which:

FIG. 1A is a cross-sectional view of an embodiment of a bearing preload spindle nut assembly shown in an engaged position, such as during preloading of wheel hub bearings.

FIG. 1B is a fragmentary perspective view of a portion of the spindle nut assembly of FIG. 1A.

FIG. 2A is a cross-sectional view of the same embodiment shown in a disengaged position, such as after successfully preloading the bearings.

FIG. 2B is a fragmentary perspective view of a portion of the spindle nut assembly of FIG. 2A.

FIG. 3 is a perspective cross-sectional view of FIG. 2A, as viewed along lines 3-3 of FIG. 2A.

FIG. 4 is a perspective full view of the bearing preload spindle nut assembly of FIGS. 1 and 2.

FIG. 5A is a cross-sectional view of pocket for containing a spring and plunger, as may be positioned within the circled inset labeled 5A, 5B in FIG. 2A

FIG. 5B is a cross-sectional view of spring and plunger detail, as positioned within the circled inset labeled 5A, 5B in FIG. 2A.

FIG. 6A is a cross-sectional view of a wheel hub supported on a spindle axle that includes a bearing preload spindle nut assembly as may be constructed in accordance with this disclosure.

FIG. 6B is a perspective embodiment of the bearing preload spindle nut assembly as may be installed on a threaded portion of the spindle of FIG. 10 in a position indicated by the dotted arrow.

FIG. 7 is a cross-sectional view of another embodiment of a bearing preload spindle nut assembly.

FIG. 8A is a perspective view of an internal friction ring employed in the bearing preload spindle nut assembly of FIG. 7.

FIG. 8B is a perspective view of a nut that includes axial projections for receiving slots formed in the ID of the internal friction rings.

FIG. 9A is a perspective view of an external friction ring employed in the same embodiment of FIG. 7.

FIG. 9B is a perspective view of the torque element that includes axial slots for receiving tabs formed on the OD of the external friction rings.

### DETAILED DESCRIPTIONS OF PRESENT EMBODIMENTS

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied otherwise by context.

As used herein, the phrase “operatively connected” refers to at least a functional relationship between two elements and may encompass configurations in which the two elements are directed connected to each other, i.e., without any intervening elements, or indirectly connected to each other, i.e., with intervening elements.

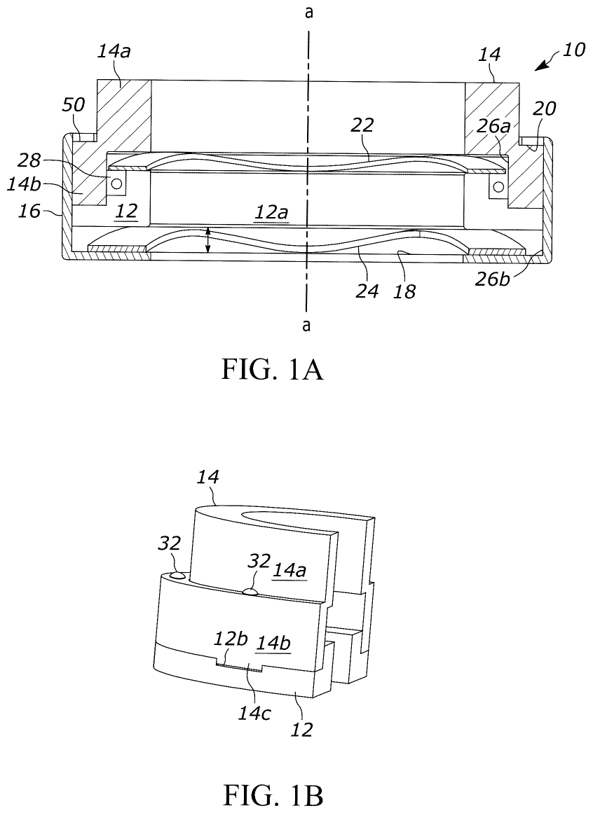

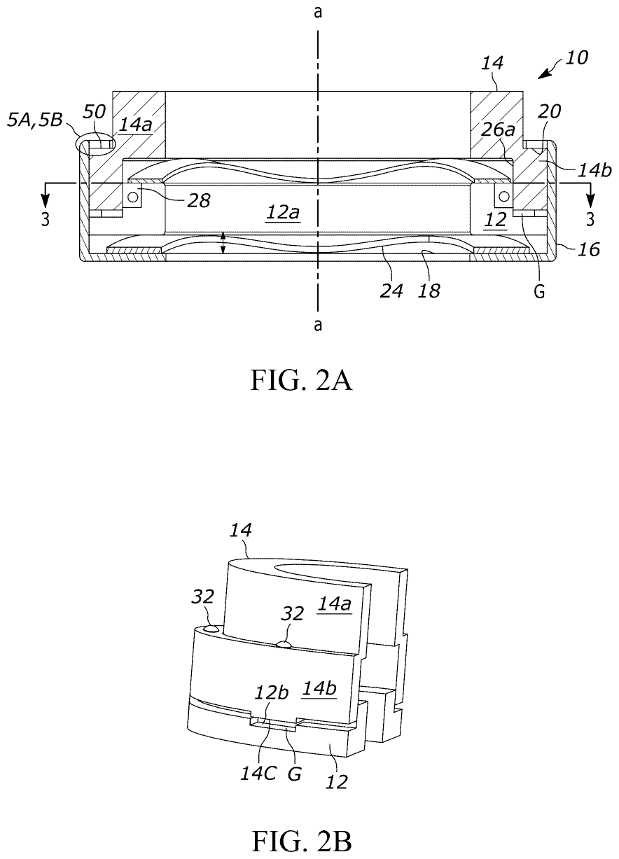

Referring initially to FIGS. 1A and 2A, a bearing preload spindle nut assembly 10 includes a nut 12, and a torque element 14. The torque element 14 is positioned axially in direct contact with the nut 12, which contains an internally threaded portion 12a for engagement with a spindle, to be described. The torque element 14 includes a hexagonal upper portion 14a and a cylindrical lower portion 14b, the portion 14b circumferentially and directly enveloping the nut 12 as in the form of a socket. The hexagonal upper portion 14a is configured to receive a wrench or other suitable tool (not shown) for engaging and physically rotating the torque element as described below with respect to the operation of the spindle nut assembly 10. An assembly cage 16 holds the above-described components together under compressive spring forces. The cage includes a thrust end 18 and a locking end 20 axially spaced from the thrust end 18. The thrust end 18 and locking end 20 axially constrains the components 12 and 14, thus assuring that the components 12 and 14 are axially urged together within the cage 16 at all times.

The cage-contained compressive spring forces are supplied by first and second pressure rings 22 and 24. The first pressure ring 22 imparts axial compressive spring forces between the torque element 14 and the nut 12. The second pressure ring 24 imparts axial compressive spring forces between the nut 12 and the thrust end 18 of the cage 16. All components of this described embodiment share a common axis a-a, displayed in FIGS. 1A and 2A.

In this disclosure, the pressure rings are defined as ring-shaped structures that when subject to rotational and axial forces will either a) impart an axially oriented spring pressure against any adjacent structure, or b) react to such forces by developing sufficient friction to prevent rotational movement relative to any adjacent structure until a predefined torque is reached. As thus defined, the ring-shaped structures of this disclosure include both wave springs and friction rings, as further described below.

In the presently described embodiment, both pressure rings 22 and 24 constitute wave springs having dimensions and performance parameters that are not identical. Indeed, the stiffnesses, thicknesses and diameters of the wave springs must be determined and manufactured to achieve a desired performance. For example, in the presently described embodiment of the spindle nut assembly the upper wave spring 22 is smaller and has a comparatively lower axial stiffness than the lower wave spring 24, for reasons explained below. Moreover, the interior wall 26a of the torque element 14 which radially envelopes wave spring 22 has an interior diameter that is less than the diameter of the interior wall 26b of the cage 16 which contains the larger wave spring 24.

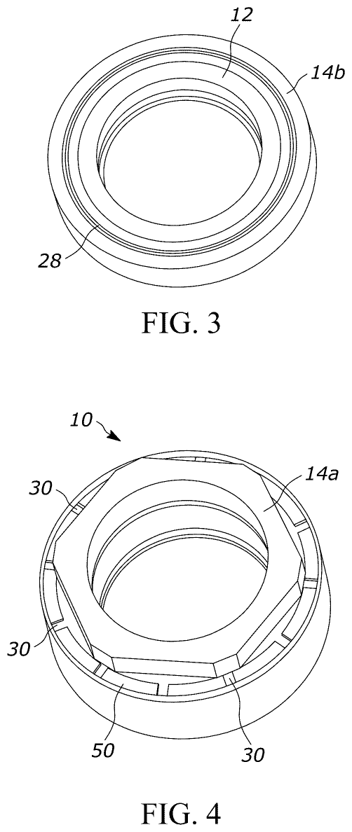

Referring now also to FIG. 3, the spindle nut assembly 10 includes a one-way clutch, such as the sprag clutch 28, shown installed within an upper exterior edge of the nut 12 (FIGS. 1A and 2A), and situated just under the outer edge or OD of the wave spring 22. The one-way clutch 28 will ensure that whenever the torque element 14 is used to remove the spindle nut assembly 10 from a spindle, rotation of the torque element 14 in the removal direction, e.g., counterclockwise, will cause the torque element 14 to positively engage and rotate the nut 12 as a single unit for removal.

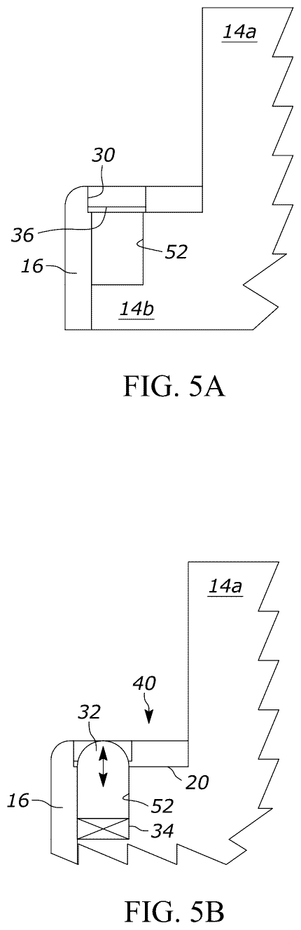

The spindle nut assembly 10 also includes an assembly lock positioned within the circumferentially extending locking end 20 of the cage 16. The lock is positioned within the circled inset labeled 5A, 5B in FIG. 2. Thus referring to FIGS. 4, 5A and 5B, the assembly lock 40 includes apertures 30, which receive spring-loaded plungers 32. The plungers 32 are urged axially by springs 34, the springs and plungers supported within cylindrical pockets 52 formed in an annular ledge 50 of the cylindrical lower portion 14b of the torque element 14. Each aperture 30 is bordered at its circumferential edge by ramps 36 to facilitate relative rotation of the torque element 14 within the cage 16; i.e., to avoid undesirable plunger extension from the apertures. Ramps are provided in all of the apertures 30 in both clockwise and counterclockwise rotational directions, allowing the torque element 14 to rotate without interference in both directions within the cage 16; i.e., during both installation and removal.

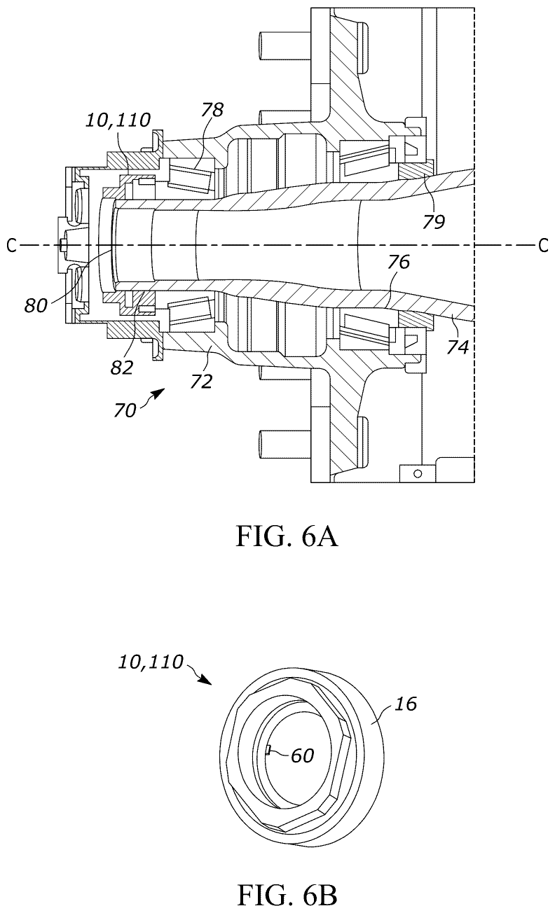

Those skilled in the art will appreciate that the cage 16 is fixed against rotation by an anti-rotation tab 60 (FIG. 6B) to an axially extending slot of a spindle. The assembly lock 40 can be selectively enabled to positively lock the assembly 10 against rotation while on the spindle by assuring that the plungers 32 have become fully extended into the apertures 30.

FIGS. 6A and 6B display an environment in which the disclosed spindle nut assembly 10 may operate. A wheel hub assembly 70 includes a wheel hub 72 supported for rotation on a spindle 74. The spindle, which in normal operation is fixed to a vehicle, has an axis c-c. The hub 72 contains a pair of bearings, including an inboard wheel bearing 76, an outboard wheel bearing 78, and a seal 79, all sharing the axis c-c. The spindle nut assembly 10 (FIG. 6B) is installed on an outboard end 80 of the spindle 74, and the axis a-a of assembly 10 then becomes coincident with axis c-c. For installation purposes, the internally threaded nut 12 of assembly 10 is secured to an exterior threaded portion 82 of the spindle 74. Those skilled in the art will appreciate that upon installation of the hub 72 onto the spindle 74, the bearings 76 and 78 are typically preloaded by torquing them to a specified value for achieving proper performance. The disclosed spindle nut assembly 10 is a self-adjusting device, capable of seating the seal and bearings, and then preloading the bearings to a predetermined torque value.

Referring once again to FIGS. 1A and 2A, the disclosed spindle nut assembly 10 includes an additional functionality for assuring its proper operation. As earlier noted, those two figures respectively show the spindle nut assembly 10 in an engaged position (FIG. 1A), such as during preloading of bearings, as well as in a disengaged position (FIG. 2A), such as after successful preloading of bearings. It will also be noted that corresponding FIGS. 1B and 2B depict views of axially extending cogs or teeth 12b and 14c. The teeth 12b are on the circumference of the nut 12, and the teeth 14c are on the outer circumference of the cylindrical lower portion 14b of the torque element 14.

It should be noted that even before the bearings are preloaded, the teeth 12b and 14c will be engaged or interlocked as shown in the views of FIGS. 1A and 1B. This is because from the time of assembly, and even prior to the mounting of the spindle nut assembly 10, the nut 12 will be urged into contact with the torque element 14. Indeed, the teeth remain engaged from time of actual assembly of the spindle nut, until a) the spindle nut assembly 10 has been installed onto the spindle 74, and b) the bearings 76 and 78 have been preloaded. Engagement of the teeth 12b and 14c in this manner permits the nut 12 and the torque element 14 to be rotated together as a single unit when a wrench is applied to the torque element 14. On the other hand, the teeth will become disengaged upon the successful preloading of the bearings, as shown in views of FIGS. 2A and 2B. When the teeth become disengaged, a gap G is formed as shown in FIGS. 2A and 2B. Physical operation of the spindle nut assembly 10 with respect to the spindle 74 may now be fully described in the preloading of the bearings 76 and 78.

When a wrench or socket tool is applied to the hexagonal upper portion 14a of the torque element 14 of the spindle nut assembly 10, the torque applied to such tool is transferred to the nut 12, rotating the internal threads 12a of the nut 12, and hence the assembly 10 onto the spindle 74. An initial axial force applied to the tool while rotating the torque element 14 in the direction of spindle nut assembly installation, e.g., clockwise, will cause the smaller wave washer 22, which creates the smaller axial spring force, to become compressed.

As torque continues to be applied to the wrench, the spindle torque element 14 and the spindle nut 12 will rotate together as a single unit within the cage 16 (FIG. 6B). The cage 16 is fixed to an axially extending slot (not shown) on the spindle 74 via the tab 60. Continued application of torque will cause the spindle nut assembly 10 to advance to engage the outer bearing 78, at which point and under increasing axial force will cause the larger and axially stiffer wave spring 24 to become further compressed until a predetermined torque threshold is reached. At that time, the bearings will have become preloaded and the teeth 12b and 14c will have disengaged, resulting in the above-described gap G (FIG. 2B). Once the preloading of the bearings 76 and 78 has been completed, a technician will complete the installation by visually ensuring that the plungers 32 are fully positioned within each of the apertures 30 for achieving a positive lock.

Removal of the spindle nut assembly 10 from the spindle 74 requires rotation of an applied wrench in a direction opposite that of installation, e.g., counterclockwise. Since upon installation the teeth 12b and 14c will have become disengaged, the operation of the one-way clutch 28 during reverse torquing of the wrench will ensure the rotation of the nut 12 and torque element 14 as a single unit to effectively achieve removal.

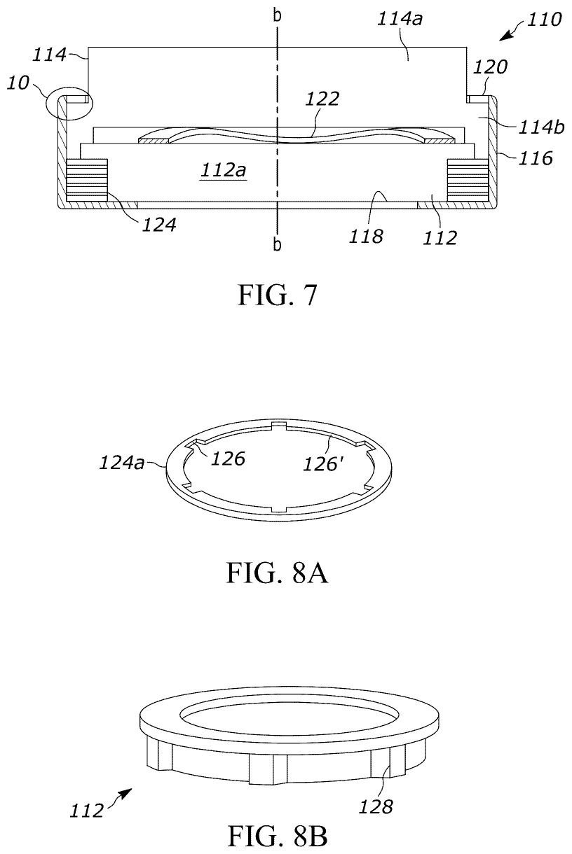

A second embodiment of a spindle nut assembly 110 is shown in FIG. 7. The assembly 110 includes a nut 112, and a torque element 114, as in the first described embodiment. The torque element 114 is also positioned axially in direct contact with the nut 112 along an axis b-b, similar to the first embodiment. The nut 112 also contains an internally threaded portion 112a for engagement with a spindle. The torque element 114 includes a hexagonal upper portion 114a and a cylindrical lower portion 114b, which circumferentially envelops the nut 112 in the form of a socket, as per the first embodiment. The hexagonal upper portion 114a is configured to receive a wrench or other suitable tool (not shown) for engaging and rotating the element 114 to install the spindle nut assembly 110. As in the first embodiment, an assembly cage 116 holds the above-described components together under compressive spring forces, the cage including a thrust end 118 and a separate locking end 120 axially spaced from the thrust end 118. The thrust end 118 and locking end 120 axially retain the components 112 and 114 under compressive spring forces to assure that the components 112 and 114 are axially held together within the cage 116.

In this embodiment, however, the cage-contained compressive spring forces are supplied only by the first pressure ring, which constitutes a single wave spring 122, as shown. The wave spring 122 imparts axial compressive spring forces between the torque element 114 and the nut 112. The second pressure ring structure is comprised of two sets of interleaved friction rings 124 (FIG. 7). Each set of friction rings is designed to slip relative to the other at a predetermined torque threshold; i.e., when the wheel bearings 76 and 78 (FIG. 6A) have been preloaded to their design specifications.

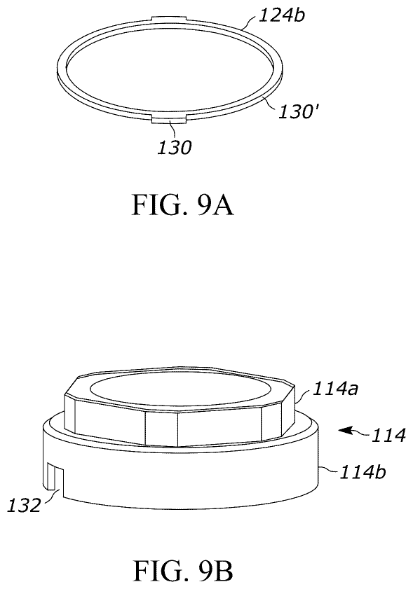

The respective sets of friction rings and the mechanism of their interaction is now described in reference to FIGS. 8 and 9. FIG. 8A is a perspective view of just one of a plurality of internal friction rings 124a that are employed in the bearing preload spindle nut assembly 110 of FIG. 7. The internal friction ring 124a contains slots 126 in its ID, shown at 126′, which engage with axial projections 128 (FIG. 8B) on the exterior of the nut 112.

FIG. 9A is a perspective view of just one of a plurality of external friction rings 124b, configured to slip relative to the internal friction rings 124a when a predetermined torque is reached, as has been described. The external friction rings include tabs 130 on their OD, shown at 130′ which engage axial slots 132 in the lower cylindrical portion 114b of the torque element 114. As configured, the internal friction rings 124a are rotatably fixed to the nut 112, while the external friction rings 124b are rotatably fixed to the torque element 114. At the threshold torque, the torque element 114 will begin to rotate about the nut 112 due to slippage between the internal and external rings.

In FIG. 7, the interface between the cylindrical lower portion 114b of the torque element 114 and the locking end 120 of the cage 116 is shown as an encircled area 10. The locking function involving spring-loaded plungers, as was described in reference to FIGS. 5A and 5B, applies equally to this embodiment.

Operation of the spindle nut assembly 110 is identical to that of the first described embodiment, even though the assembly 110 relies only upon the operation of the described pressure rings 122 and 124. As such, the assembly 110 does not require inclusion of the one-way clutch for spindle nut removal, nor the circumferential teeth engagement between nut and torque element for installation, as were included in the first described embodiment of the spindle nut assembly 10.

Finally, with respect to the assembly 110, it has been noted that the respective friction rings 124a and 124b are designed to slip when subjected to any torque value that exceeds a predefined torque threshold during installation preloading of wheel hub bearings. During removal of the assembly 110, however, the removal torque required is estimated to be about 10% less than the applied torque for installation. The reason is that upon spindle nut removal, the required torque for loosening the nut will be lower because the external and internal rings will already be in a frictionally engaged state, thus requiring less torque for removal.

While various embodiments in accordance with the instant disclosure have been described in conjunction with specific implementations thereof, it is evident that alternatives, modifications, and variations will be apparent to those skilled in the art. For example, shapes, sizes, and configurations of the structures described may be varied without departing from the intended spirit and scope of the invention. Accordingly, any preferred embodiments of the invention as set forth herein are intended to be illustrative only and not limiting, so long as the variations thereof fall within the scope of the appended claims and their equivalents.

What is claimed is:

1. A spindle nut assembly for securing a wheel hub to a wheel spindle, the hub being supported on wheel bearings for rotation about an axis of the spindle; the assembly including an axis configured to coincide with the axis of the spindle, the assembly comprising:
a) an internally threaded nut;
b) a torque element situated axially adjacent the nut;
c) a cage holding the nut and torque element axially together under compressive spring forces, the cage including a thrust end and a locking end axially spaced from the thrust end; and
the assembly further comprising a first pressure ring axially interposed between the nut and the torque element, and a second pressure ring axially interposed between the nut and the thrust end, the first and second pressure rings cooperating to provide a torque threshold limit for preloading the wheel bearings when the torque element is rotated in a first direction while axially urged against the nut.

2. The spindle nut assembly of claim 1, wherein the locking end and the torque element comprise a spindle nut assembly lock for selectively preventing rotation of the torque element and nut relative to the cage.

3. The spindle nut assembly of claim 1, wherein each of the first and second pressure rings comprises a wave spring, and wherein the second pressure ring is axially stiffer than the first.

4. The spindle nut assembly of claim 1, further comprising an assembly lock that includes a plurality of apertures in the locking end of the cage, and a plurality of spring-loaded plungers extending axially from the torque element, and wherein the plungers are selectively engageable with the apertures.

5. The spindle nut assembly of claim 1, wherein the cage includes an anti-rotation tab at its thrust end, the tab configured for engagement with an axially extending slot in the spindle.

6. The spindle nut assembly of claim 1, wherein the cage encompasses the nut and torque element in a manner that supports their relative rotations within the cage.

7. The spindle nut assembly of claim 1, further comprising a one-way clutch positioned between the nut and torque element, wherein the clutch becomes engaged, and causes the torque element to rotate the nut when the torque element is rotated in a second direction.

8. The spindle nut assembly of claim 1, wherein the nut and the torque element comprise interacting teeth that become disengaged when the bearings become preloaded.

9. The spindle nut assembly of claim 1, wherein the first pressure ring is axially retained between the nut and the torque element, and radially constrained by an interior wall of the torque element.

10. The spindle nut assembly of claim 1, wherein the second pressure ring is axially constrained between the nut and the thrust end of the cage before radially constrained by an interior wall of the cage.

11. A spindle nut assembly for securing a wheel hub to a wheel spindle, the hub being supported on wheel bearings for rotation about an axis of the spindle; the assembly including an axis configured to coincide with the axis of the spindle, the assembly comprising:
a) an internally threaded nut;
b) a torque element situated axially adjacent the nut;
c) a cage holding the nut and torque element axially together under compressive spring forces, the cage including a thrust end, the cage further including a locking end axially spaced from the thrust end;
the assembly further comprising a wave spring axially interposed between the nut and the torque element, and a plurality of pressure rings axially interposed between the nut and the thrust end, the wave spring and pressure rings defining at least two axially spaced components configured to provide a torque threshold limit for preloading the wheel bearings when the torque element is rotated in a first direction while axially urged against the nut; and
wherein the locking end and the torque element comprise a spindle nut assembly lock for selectively preventing rotation of the torque element and nut relative to the cage.

12. The spindle nut assembly of claim 11, wherein the plurality of pressure rings comprise cooperating interleaved external and internal friction rings, with the external friction rings connected to the torque element, and the internal friction rings connected to the nut.

13. The spindle nut assembly of claim 11, wherein the assembly lock comprises a plurality of apertures in the locking end of the cage, and a plurality of spring-loaded plungers extending axially from the torque element, wherein the plungers are selectively engageable with the apertures.

14. The spindle nut assembly of claim 11, wherein the cage includes an anti-rotation tab at its thrust end, with the tab configured for engagement with an axially extending slot in the spindle.

15. The spindle nut assembly of claim 11, wherein the wave spring is axially retained between the nut and the torque element, and radially constrained by an interior wall of the torque element.

16. The spindle nut assembly of claim 12, wherein the exterior and internal friction rings slip relative to each other under predetermined torque loads.

17. The spindle nut assembly of claim 16, wherein the torque element includes axial slots configured for preventing relative rotation of the external friction rings with respect to the torque element, and wherein the nut includes axial projections configured for preventing relative rotation of the internal friction rings with respect to the nut.

18. The spindle nut assembly of claim 17, wherein the external friction rings have tabs engaged with the axial slots of the torque element, and the internal friction rings have internal slots engaged with the axial projections on the nut.

19. The spindle nut assembly of claim 17, wherein the external friction rings are fixed to and rotate with the torque element, and the internal friction rings are fixed to and rotate with the nut.

20. A method of forming a spindle nut assembly for securing a wheel hub to a wheel spindle, the hub being supported on wheel bearings for rotation about an axis of the spindle, the assembly including an axis configured to coincide with the axis of the spindle, the method comprising steps of:
a) forming an internally threaded nut;
b) forming a torque element to be situated axially adjacent the nut;
c) forming a cage to hold the nut and torque element axially together under compressive spring forces, with the cage including a thrust end, and with the cage further including a locking end axially spaced from the thrust end;
d) forming a wave spring to be axially interposed between the nut and the torque element;
e) forming a plurality of friction rings to be axially interposed between the nut and the thrust end; and
f) assembling the torque element, the nut, the wave spring, and the friction rings within the cage,
wherein the wave spring and friction rings cooperate to provide a torque threshold limit for preloading the wheel bearings when the torque element is axially urged against the nut and is rotated in a first direction.

21. A method of forming a spindle nut assembly for securing a wheel hub to a wheel spindle, the hub being supported on wheel bearings for rotation about an axis of the spindle, the assembly including an axis configured to coincide with the axis of the spindle, the method comprising steps of:
a) forming an internally threaded nut;
b) forming a torque element to be situated axially adjacent the nut;
c) forming a cage to hold the nut and torque element axially together under compressive spring forces, with the cage including a thrust end, and with the cage further including a locking end axially spaced from the thrust end;
d) forming a first wave spring to be axially interposed between the nut and the torque element;
e) forming a second wave spring to be axially interposed between the nut and the thrust end; and
f) assembling the torque element, the nut, and wave springs within the cage,
wherein the wave springs cooperate to provide a torque threshold limit for preloading the wheel bearings when the torque element is axially urged against the nut and is rotated in a first direction.
